(19) United States
(12) Patent Application Publication
(10) Pub. No.: US 2012/0167663 A1
(43) Pub. Date: Jul. 5, 2012

(54) LASER-BASED METHOD FOR FRICTION COEFFICIENT CLASSIFICATION IN MOTOR VEHICLES

(75) Inventors: Stéphan Groitzsch, Weinheim (DE); Matthias Schorn, Muhltal (DE); Daniel Fischer, Schwalbach (DE); Stefan Stölzl, Weinheim (DE)

(73) Assignees: CONTINENTAL ENGINEERING SERVICES GMBH, Frankfurt (DE); CONTINENTAL TEVES AG & CO. OHG, Frankfurt (DE)

(21) Appl. No.: 13/383,434

(22) PCT Filed: Jul. 19, 2010
(86) PCT No.: PCT/EP10/60416

§ 371 Date: Mar. 19, 2012

(30) Foreign Application Priority Data
Jul. 17, 2009 (DE) 10 2009 033 745.8

(51) Int. Cl. G01N 21/47; G01J 3/30; G01N 21/55

(52) U.S. Cl. 73/9

(57) ABSTRACT

A sensor arrangement for capturing the coefficient of friction from a roadway surface, wherein the sensor arrangement is arranged on a motor vehicle and includes at least one radiation emitter unit and at least one electronic evaluation circuit, wherein the radiation emitter unit emits electromagnetic radiation toward the roadway surface and the radiation is at least to some extent reflected and/or scattered at the roadway surface and the reflected and/or scattered radiation is at least to some extent captured in the radiation emitter unit and/or in one or more additional sensor units, wherein the electronic evaluation circuit is designed such that it ascertains a piece of coefficient-of-friction information for the roadway surface from the intensity of the reflected and/or scattered radiation or a variable which is dependent thereon.

### CROSS REFERENCE TO RELATED APPLICATIONS

This application is the U.S. National Phase Application of PCT/EP2010/060416, filed Jul. 19, 2010, which claims priority to German Patent Application No. 10 2009 033 745.8, filed Jul. 17, 2009, the contents of such applications being incorporated by reference herein.

### FIELD OF THE INVENTION

The invention relates to a sensor arrangement for capturing the coefficient of friction from a roadway surface and to a method for classifying coefficients of friction in motor vehicles having a sensor arrangement.

### BACKGROUND OF THE INVENTION

Modern electronic driver assistance and driving dynamics systems are frequently reliant on accessing a piece of information or at least making assumptions about the adhesion coefficient between roadway and tires. An example which may be mentioned is a driver assistance system for avoiding accidents. In the case of such a system, it is of great importance to know the adhesion coefficient and to take account of it when calculating warning and intervention times. If the adhesion coefficient is assumed to be too low, the system would provide warnings or intervene too early and in this way dictate to the driver. Systems of corresponding design would be accepted by drivers only with difficulty. If the adhesion coefficient is assumed to be too high, the system provides warnings or intervenes too late, which means that it may no longer be possible to prevent a collision, for example.

Besides the cited example, there are numerous further driver assistance and driving dynamics systems whose system response could be improved by a piece of information about the adhesion coefficient. Furthermore, the driver can be informed about poor roadway/tire contact in order to be able to adapt his manner of driving accordingly.

The following approaches are currently used in electronic brake systems in order to prescribe or ascertain the adhesion coefficient:
assuming a fixed value for the adhesion coefficient
indirectly determining the adhesion coefficient by means of mathematical methods from other variables measured (directly) in the vehicle. For estimating the adhesion coefficient it is possible to use nonlinear state estimators or Kalman filters for example.

The first course of action mentioned, assuming a fixed adhesion coefficient, is used in some systems, including driver assistance systems for avoiding accidents. Usually, ideal adhesion between tires and road is assumed for the calculations of warning and/or intervention times, for example. This can result in warnings/intervention coming too late if the adhesion coefficient is low—a collision cannot be prevented.

The second method cited is used for driving dynamics controllers, for example. In this case, directly measured vehicle variables are taken as a basis for estimating the utilized adhesion coefficient. When dynamic driving situations exist, relatively good results can be obtained. If the vehicle is in a driving situation with only minor accelerations, however, these approaches no longer necessarily result in the desired success, since the adhesion coefficient utilized is significantly smaller in this case than the real one.

### SUMMARY OF THE INVENTION

The invention proposes a sensor arrangement and a method which is used to allow relatively precise ascertainment of a piece of coefficient-of-friction information for the roadway surface, particularly even in uniform driving states of the motor vehicle.

The invention achieves this by means of a sensor arrangement for capturing the coefficient of friction from a roadway surface, wherein the sensor arrangement is arranged on a motor vehicle and has at least one radiation emitter unit and at least one electronic evaluation circuit, wherein the radiation emitter unit emits electromagnetic radiation toward the roadway surface and the radiation is at least to some extent reflected and/or scattered at the roadway surface and the reflected and/or scattered radiation is at least to some extent captured in the radiation emitter unit and/or in one or more additional sensor units, wherein the electronic evaluation circuit is designed such that it ascertains a piece of coefficient-of-friction information for the roadway surface from the intensity of the reflected and/or scattered radiation or a variable which is dependent thereon and by means of a method for classifying coefficients of friction in motor vehicles having a sensor arrangement, particularly the aforementioned sensor arrangement, wherein the sensor arrangement is arranged on a motor vehicle and comprises at least one radiation emitter unit and at least one electronic evaluation circuit, wherein the radiation emitter unit emits electromagnetic radiation toward the roadway surface and the radiation is at least to some extent reflected and/or scattered at the roadway surface and the reflected and/or scattered radiation is at least to some extent captured in the radiation emitter unit and/or in one or more additional sensor units, wherein subsequently the electronic evaluation circuit ascertains a piece of coefficient-of-friction information for the roadway surface from the intensity of the reflected and/or scattered radiation or a variable which is dependent thereon.

The coefficient-of-friction information is preferably understood to mean an adhesion coefficient.

It is preferred for the electronic evaluation circuit to be designed such that it classifies the intensity values or variables which are dependent thereon, which are provided by the at least one radiation emitter unit and/or the one or more additional sensor units when the reflected and/or scattered radiation is captured, in a classifier unit, wherein the classifier unit calculates the coefficient-of-friction information, as a coefficient of friction or a coefficient-of-friction type or a coefficient-of-friction range, and provides at least one piece of quality information, in particular, which contains a piece of information about the validity and/or the reliability of the coefficient-of-friction information.

The classifier unit in the electronic evaluation circuit is expediently designed such that it performs frequency analysis of the radiation capture output signals from the at least one radiation emitter unit and/or the one or more additional sensor units and, particularly after the frequency analysis, recognizes and/or captures an energy distribution pattern based on one or more defined frequency ranges and/or based on energy levels in defined frequency bands and associates the coefficient-of-friction information with said energy distribution pattern taking account of reference criteria and/or reference energy distribution patterns.

The radiation capture output signals are preferably understood to mean the output signals from the at least one radiation emitter unit and/or the one or more additional sensor units, which are dependent on the captured reflected and/or scattered radiation or encode it or encode the correspondingly captured intensity of said radiation. The radiation capture output signals are digital signals or series of values, in particular.

The classifier unit in the electronic evaluation circuit is expediently designed such that it determines the quality information on the basis of the variance and/or the standard deviation, particularly weighted using fuzzy logic, of the radiation capture output signals from the at least one radiation emitter unit and/or the one or more additional sensor units.

The classifier unit in the electronic evaluation circuit is preferably designed such that it determines the quality information by taking account of further parameters for checking the plausibility of the coefficient-of-friction information, such as at least one of the following parameters: a piece of temperature information and/or a piece of rain sensor information and/or a piece of time/date information.

It is preferred for the sensor arrangement to have a plurality of radiation emitter units which are arranged in the vehicle at a defined distance from one another, based on a parallel to the roadway surface, wherein said radiation emitter units are all essentially directed at a common point or at a common target area on the roadway surface.

As an alternative preference, the sensor arrangement has a plurality of radiation emitter units integrated in a common cluster unit, wherein said radiation emitter units are each directed at different points on the roadway surface.

It is preferred for the one or more radiation emitter units to comprise a or a respective laser element which emits the radiation and particularly a photoelement which captures the reflected and/or scattered radiation.

It is expedient for the photoelement to be in the form of a photodiode and particularly for the one or more radiation emitter units or each radiation emitter unit to be in the form of a vertical cavity surface emitting laser with an integrated photodiode.

As an alternative preference, one or more of the radiation emitter units comprises a or a respective laser element which both emits and senses or captures the radiation, particularly by virtue of superimposition in the laser. With particular preference, the radiation emitter unit has no additional sensor element for this.

The sensor arrangement is preferably designed such that it additionally ascertains at least one speed, particularly the vehicle longitudinal speed, for the motor vehicle relative to the roadway surface, and/or ascertains the distance of the vehicle chassis from the roadway surface, from the radiation reflected at the roadway surface, this being done particularly preferably using the same radiation emitter unit and the same electronic evaluation circuit. With very particular preference, the sensor arrangement is designed to capture both a vehicle speed and the distance of the vehicle chassis from the roadway surface, switching between these capture operations in each case.

The electronic evaluation circuit is preferably connected to a central electronic control unit, particularly a motor vehicle control system or motor vehicle brake system, for the purpose of determining the coefficient-of-friction information and/or the quality information.

The classifier unit preferably comprises a low pass filter on the input side.

The sensor arrangement preferably captures the reflected and scattered radiation essentially in separate units, particularly in radiation emitter units and additional sensor units, which to this end are arranged offset from one another or at a distance from one another in relation to a roadway surface parallel.

The classifier unit is expediently designed such that it essentially performs separate processing, at least separate preprocessing, for the radiation capture output signals from the units which primarily capture the reflected radiation and in this case is particularly preferably the same unit or are the same units as emits/emit the radiation, or arranged in direct proximity to the emitting unit(s) and from the units which primarily capture the scattered radiation and in this case are particularly preferably arranged at a defined distance from the emitting unit or the emitting units, after which the coefficient-of-friction information and/or the quality information is ascertained collectively.

The at least one radiation emitter unit is preferably in the form of a laser which emits monochromic, continuous, infrared laser light.

The present invention preferably describes an exemplary sensor arrangement and an exemplary method which can be used to improve the estimation of the adhesion coefficient, as a result of which reliable and robust classification of the adhesion between roadway and tires can be performed even in nondynamic driving situations. The cited method can be used to determine the adhesion coefficient between tires and roadway or to estimate an adhesion coefficient class on the basis of the reflection and absorption properties of the nature of the roadway surface in conjunction with an intermediate medium (e.g. water). To obtain greater robustness, it is possible for already existing estimation and/or measurement methods to be augmented with the cited input information.

As one specific embodiment, the sensor arrangement is preferably designed such or the at least one radiation emitter unit is arranged and oriented such that the roadway surface ahead of the vehicle is scanned so as to obtain a preview of the coming adhesion coefficient. This allows better reaction to changing adhesion coefficients.

Expediently, the at least one radiation emitter unit is both an emitter and a receiver or sensor. In this case, the relative motion between the emitter and the roadway surface in the beam direction results in a frequency shift in the reflected light, which is also known as the “Doppler effect”. This method of measurement is distinguished in that the laser emitter is simultaneously used as a measurement cell and transmitted and received photons interfere at that location (“self-mixing”). By way of example, frequency analysis is used to ascertain the difference frequency between emitted and reflected photons from the interference signal. The amplitude of the frequencies present in the spectrum can be used to derive a statement about the reflectivity of the ground. Such a “self-mixing” laser system is a vertical cavity surface emitting laser, for example.

The advantages of the method proposed by way of example and of the exemplary sensor arrangement over other optical methods are as follows, for example:
The IR light used is invisible to human beings and therefore cannot disturb other road users.
Transmitted and reflected photons are in an exact phase relationship with one another (coherent laser light), which means that other sources, even those at the same frequency, are not captured by the measurement cell.
The technology described is now available in large scale integrated form, which allows inexpensive implementation and simple integration in the vehicle.
The fact that the transmission and measurement units are integrated in one component reduces the costs and increases the precision.
With this technology, the power emitted by the laser can be chosen to be so low that no damage results even from direct radiation into the human eye (e.g. mechanic).
The small beam diameter of the focused laser requires only small “outlet windows”, which means that the system could easily be protected against soiling.
The inexpensive, miniaturized design of VCSELs allows a plurality of lasers to be integrated in one component, which means that it is possible to capture a plurality of measurement directions and/or to capture measurement directions redundantly.

A preferred, suitable geometric arrangement of a plurality of lasers can be used to capture the backscatter or reflection at different angles of incidence. This allows a backscatter profile to be produced on the basis of the angle of incidence, which profile is characteristic of the nature of any roadway surface. Whereas in the case of rough surfaces, for example, an almost homogeneous reflection profile (similar backscatter at all angles) can be expected, smooth surfaces exhibit less backscatter for acute angles of incidence than for obtuse ones (ideal mirror: backscatter or reflection only when the laser beam hits the roadway perpendicularly).

On the basis of the different levels of backscatter at the angles of incidence used for measurement, it is possible to determine the prevalent combination of reflectivity/roughness of the ground and of the intermediate medium situated on the roadway, for example. This information can be used to infer the adhesion between roadway and tires which is prevalent when ordinary pneumatic rubber tires are used.

Further possibilities/preferred method steps for signal evaluation are:
Frequency analysis of the amplitude signal: it is to be expected that different grounds exhibit different reflection patterns which show up in the spectrum.
Standard deviation of the amplitude signal: it is to be expected that different grounds exhibit different standard deviations.
Use of filters with a particular frequency profile: it is to be expected that characteristic information relating to the coefficient of friction in a particular frequency range is available which is specifically extracted from the amplitude signal.
The range signal from a sensor provides information about the roughness of the roadway. Rough roadways have different coefficients of friction, or this could be an indication of loose snow or chippings.
The amplitude signal can also be used relatively: if the current coefficient of friction is known from another system for estimating coefficients of friction, and the amplitude signal exhibits a step, then it is possible to infer a rapid step in the coefficient of friction.

It is expedient for the sensor arrangement to have at least one CV sensor (closing velocity sensor) for roadway surface capture. A CV sensor is understood particularly to mean a sensor which is otherwise used for distance measurement between vehicles when mounted in a vehicle.

### BRIEF DESCRIPTION OF THE DRAWINGS

The invention is best understood from the following detailed description when read in connection with the accompanying drawing. Included in the drawing are the following figures:

In a schematic, exemplary illustration,

FIG. 1 shows a sensor arrangement with three laser sensors, lasers 1-3, as radiation emitter units,

FIG. 2 shows a sensor arrangement comprising a cluster unit or a laser sensor cluster,

FIG. 3 shows signal processing or a method flowchart for classifying coefficients of friction with an optical sensor,

FIG. 4 shows classification of different roadway surfaces with a CV sensor (closing velocity sensor), and

FIG. 5 shows an exemplary signal profile for the classification of coefficients of friction with an exemplary sensor arrangement, in accordance with the example with a CV sensor.

### DETAILED DESCRIPTION OF THE PREFERRED EMBODIMENTS

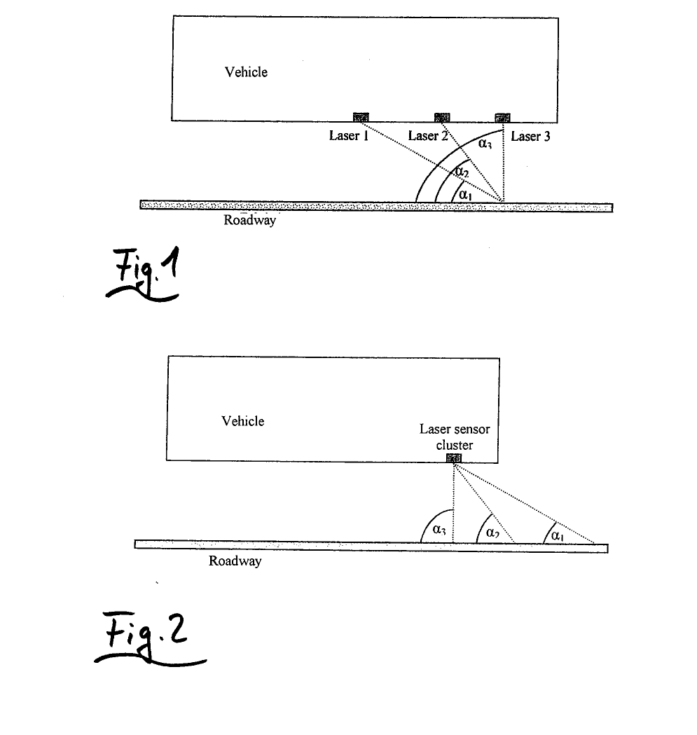

According to the example, all laser beams or the laser beams from lasers 1-3 should meet at a point on the ground, as shown in FIG. 1, in order to obtain the backscatter profile at exactly this point. In an alternative, exemplary embodiment, a laser sensor cluster (housing) with a plurality of laser emitters and sensors is used in which the different laser beams are emitted from (approximately) one point, as illustrated by means of FIG. 2, but do not hit the roadway at one point on account of the different angles. Assuming that the nature of the roadway is homogeneous, corresponding effects are negligible.

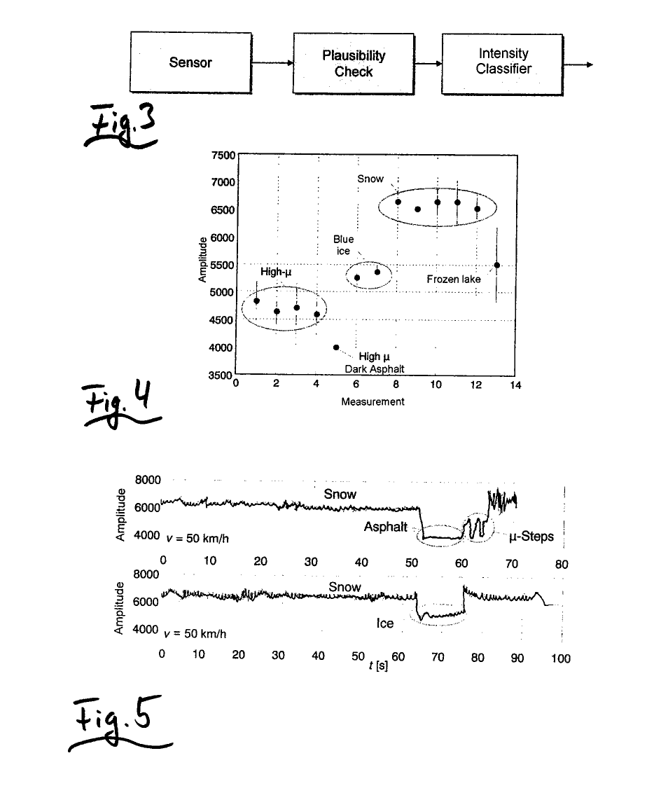

The signal evaluation by a system for estimating coefficients of friction is shown by way of example in FIG. 3, the function blocks Plausibility Check and Intensity Classifier belonging to the classifier unit in the electronic evaluation circuit or being part of this circuit. First of all, a plausibility check takes place. This ensures that only measured values which involve the roadway actually being surveyed are used. If the sensor captures the speed, for example, then it is necessary to check that the measured speed is in the same range as the speed which is measured by wheel speed sensors, for example. If the sensor captures the distance, for example, then it is necessary to check that the measured distance is in the range of the typical sensor/roadway distance.

In the second step, the plausibility checked signal is used to classify the roadway situation and therefore indirectly the coefficient of friction. The main feature in this case is the amplitude. As FIG. 4 shows, amplitude ranges can be associated with different roadway natures. This association could be made by a fuzzy logic module, for example. Each amplitude range has an associated coefficient of friction which is weighted proportionally in the range transitions.

To describe the effect, the roadway surfaces indicated in FIG. 4 have been surveyed first of all. The points each represent the average and the error bars represent the standard deviation of a measurement, with measurements 1-4 and 13 showing longer journeys of 20 minutes. It is possible to see a distinct distinguishability for the different roadways.

FIG. 5 shows the time profile of the signal or of the output signal from the CV sensor. In this case too, distinct and also very fast recognition of the different grounds can be seen. In particular, it is even possible to see a multiple μ step in the top illustration, the asphalt surfaces having been only approximately 5 m long.

1. A sensor arrangement for capturing a coefficient of friction from a roadway surface, wherein the sensor arrangement is arranged on a motor vehicle and has at least one radiation emitter unit and at least one electronic evaluation circuit, wherein the radiation emitter unit emits electromagnetic radiation toward the roadway surface and the radiation is at least to some extent at least one of reflected and scattered at the roadway surface and the at least one of reflected and scattered radiation is at least to some extent captured in the at least one of radiation emitter unit and in one or more additional sensor units, wherein
the electronic evaluation circuit is designed such that it ascertains a piece of coefficient-of-friction information for the roadway surface based on an intensity of the reflected and/or scattered radiation or a variable which is dependent thereon.

2. The sensor arrangement as claimed in claim 1, wherein the electronic evaluation circuit is designed such that it classifies the intensity values or variables which are dependent thereon, which are provided by the at least one radiation emitter unit and/or the one or more additional sensor units when the reflected and/or scattered radiation is captured, in a classifier unit, wherein the classifier unit calculates the coefficient-of-friction information, as a coefficient of friction or a coefficient-of-friction type or a coefficient-of-friction range, and provides at least one piece of quality information, in particular, which contains a piece of information about the validity and/or the reliability of the coefficient-of-friction information.

3. The sensor arrangement as claimed in claim 1, wherein the classifier unit of the electronic evaluation circuit is designed such that it performs frequency analysis of the radiation capture output signals for the at least one radiation emitter unit and/or the one or more additional sensor units and, after the frequency analysis, recognizes and/or captures an energy distribution pattern based on a defined frequency range and/or based on energy levels in defined frequency bands and associates the coefficient-of-friction information with said energy distribution pattern taking account of reference criteria and/or reference energy distribution patterns.

4. The sensor arrangement as claimed in claim 2, wherein the classifier unit of the electronic evaluation circuit is designed such that it determines the quality information on the basis of the variance and/or the standard deviation, weighted using fuzzy logic, of the radiation capture output signals from the at least one radiation emitter unit and/or the one or more additional sensor units.

5. The sensor arrangement as claimed in claim 2, wherein the classifier unit of the electronic evaluation circuit is designed such that it determines the quality information by taking account of further parameters for checking the plausibility of the coefficient-of-friction information.

6. The sensor arrangement as claimed in claim 1, wherein the sensor arrangement has a plurality of radiation emitter units which are arranged in the vehicle at a defined distance from one another, based on a parallel to the roadway surface, wherein said radiation emitter units are all essentially directed at a common point or at a common target area on the roadway surface.

7. The sensor arrangement as claimed in claim 1, wherein the sensor arrangement has a plurality of radiation emitter units integrated in a common cluster unit, and wherein said radiation emitter units are each directed at different points on the roadway surface.

8. The sensor arrangement as claimed in claim 1, wherein the at least one radiation emitter unit comprises a laser element which emits the radiation and a photoelement which captures the reflected and/or scattered radiation.

9. The sensor arrangement as claimed in claim 8, wherein the photoelement is in the form of a photodiode and the at least one radiation emitter unit or each radiation emitter unit is in the form of a vertical cavity surface emitting laser with an integrated photodiode.

10. The sensor arrangement as claimed in claim 1, wherein the sensor arrangement is designed such that it additionally ascertains at least one speed for the motor vehicle relative to the roadway surface from the radiation reflected at the roadway surface, this being done using the same radiation emitter unit and the same electronic evaluation circuit.

11. A method for classifying coefficients of friction in motor vehicles having a sensor arrangement, particularly a sensor arrangement as claimed in claim 1, wherein the sensor arrangement is arranged on a motor vehicle and comprises at least one radiation emitter unit and at least one electronic evaluation circuit, wherein the radiation emitter unit emits electromagnetic radiation toward the roadway surface and the radiation is at least to some extent reflected and/or scattered at the roadway surface and the reflected and/or scattered radiation is at least to some extent captured in the radiation emitter unit and/or in one or more additional sensor units, wherein
subsequently the electronic evaluation circuit ascertains a piece of coefficient-of-friction information for the roadway surface from the intensity of the reflected and/or scattered radiation or a variable which is dependent thereon.

12. The method as claimed in claim 11, wherein the intensity values or variables which are dependent thereon, which are provided by the at least one radiation emitter unit and/or the one or more additional sensor units when the reflected and/or scattered radiation is captured, are classified in a classifier unit in the electronic evaluation circuit, wherein the classifier unit calculates the coefficient-of-friction information, as a coefficient of friction or a coefficient-of-friction type or a coefficient-of-friction range, and provides at least one piece of quality information which contains a piece of information about the validity and/or the reliability of the coefficient-of-friction information.

13. The method as claimed in claim 12, wherein the classifier unit in the electronic evaluation circuit performs frequency analysis of the radiation capture output signals from the at least one radiation emitter unit and/or the one or more additional sensor units and, following the frequency analysis, recognizes and/or captures particularly an energy distribution pattern based on a defined frequency range and/or based on energy levels in defined frequency bands and associates the coefficient-of-friction information with said energy distribution pattern taking account of reference criteria and/or reference energy distribution patterns.

14. The sensor arrangement as claimed in claim 3, wherein the classifier unit of the electronic evaluation circuit is designed such that it determines the quality information on the basis of the variance and/or the standard deviation, weighted using fuzzy logic, of the radiation capture output signals from the at least one radiation emitter unit and/or the one or more additional sensor units.

15. The sensor arrangement as claimed in claim 5, wherein the further parameters for checking the plausibility of the coefficient-of-friction information include at least one of a piece of temperature information, a piece of rain sensor information, and a piece of time/date information.
